(19) United States
(12) Patent Application Publication
(10) Pub. No.: US 2026/0156172 A1
(43) Pub. Date: Jun. 4, 2026

(54) DATA BURST SIZE CORRECTION USING PRE-COMPENSATION OR OVER-PROVISIONING FOR MEDIA DATA COMMUNICATION

(71) Applicant: QUALCOMM Incorporated, San Diego, CA (US)

(72) Inventors: Liangping Ma, San Diego, CA (US); Imed Bouazizi, Celina, TX (US)

(21) Appl. No.: 19/404,771

(22) Filed: Dec. 1, 2025

Related U.S. Application Data
(60) Provisional application No. 63/727,033, filed on Dec. 2, 2024.

(51) Int. Cl. H04L 65/75; H04L 47/36

(52) U.S. Cl. CPC H04L 65/765; H04L 47/36

(57) ABSTRACT

An example device for exchanging media data includes a processing system implemented in circuitry and configured to: calculate a cumulative size of packets of a data burst received from a source device, the packets including media data; determine a signaled data burst size for the data burst; calculate a ratio between the cumulative size and the signaled size; and send data representative of the ratio to the source device. Another example device for exchanging media data includes a processing system implemented in circuitry and configured to: determine an initial data burst size value for a data burst including packets including media data; signal a signaled data burst size value for the data burst, the signaled data burst size value being larger than the initial data burst size value; and send the data burst including the signaled data burst size value to a destination device.

This application claims the benefit of U.S. Provisional Application No. 63/727,033, filed Dec. 2, 2024, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging media data. In particular, when exchanging media data via a network, media data may be encapsulated into network packets, which may be transmitted in data bursts. In some cases, a data burst may include a set of packets that have been grouped into protocol data unit (PDU) Sets, where a PDU Set includes a group of packets carrying an application data unit (such as a frame of video data, or a slice of a frame of video data). However, generally, data bursts may simply correspond to one or more IP packets (also referred to simply as “packets”), which need not be formed into PDU Sets. A data burst size value may be sent to indicate the amount of expected data for a data burst, such that an intermediate network device, such as a base station of a radio access network (RAN), can perform resource allocation accordingly. The burst size may include packet headers (e.g., headers for real-time transport protocol (RTP), user datagram protocol (UDP), Internet protocol (IP), or the like).

Packets may become fragmented, and various networks support various IP address types, e.g., IPv4 vs. IPv6. The routers in the middle of the end-to-end path may add additional packet headers, e.g., segment routing header (SRH). However, changes to IP address types as packets traverse a network, IP fragmentation, and segment routing, may lead to the data burst size for a data burst being inaccurate to a network device, such as a base station in a cellular network, which may result in a waste of resources or insufficient resources in resource allocation. This disclosure describes techniques by which a sending device may pre-compensate for such issues, which may include altering a calculated data burst size. For example, the destination device may send an indicator, e.g., a ratio value representing a ratio of actual data burst size to the signaled data burst size, and the source device may multiply a newly calculated data burst size by the ratio to compute a new signaled data burst size for a subsequent data burst.

Additionally or alternatively, the source device or an intermediate network device may over-provision resources, including determining an initial data burst size, then signaling a larger data burst size for the corresponding data burst. For example, a source device may calculate an expected data burst size for a data burst, then preemptively signal a larger than calculated data burst size for the data burst. Additionally or alternatively, an intermediate network device, such as a router that executes a user plane function (UPF) to encapsulate packets with a tunnel header for network tunneling, may extract a signaled data burst size for the packets, then signal a larger-than-signaled data burst size in the tunnel header for the tunneled packets. Additionally or alternatively, a base station of a radio access network (RAN) may provision resources according to a larger than signaled data burst size value for the data burst.

In one example, a method of exchanging media data includes: calculating a cumulative size of packets of a data burst received from a source device, the packets including media data; determining a signaled data burst size for the data burst; calculating a ratio between the cumulative size and the signaled size; and sending data representative of the ratio to the source device.

In another example, a device for exchanging media data includes: a memory; and a processing system implemented in circuitry and configured to: calculate a cumulative size of packets of a data burst received from a source device, the packets including media data; determine a signaled data burst size for the data burst; calculate a ratio between the cumulative size and the signaled size; and send data representative of the ratio to the source device.

In another example, a method of exchanging media data includes: determining an initial data burst size value for a data burst including packets including media data; signaling a signaled data burst size value for the data burst, the signaled data burst size value being larger than the initial data burst size value; and sending the data burst including the signaled data burst size value to a destination device.

In another example, a device for exchanging media data includes: a memory; and a processing system implemented in circuitry and configured to: determine an initial data burst size value for a data burst including packets including media data; signal a signaled data burst size value for the data burst, the signaled data burst size value being larger than the initial data burst size value; and send the data burst including the signaled data burst size value to a destination device

In another example, a method of exchanging media data includes: receiving a data burst size value for a data burst including packets of media data; determining a larger data burst size value that is larger than the received data burst size value; allocating resources for receiving the data burst according to the larger data burst size value; and receiving the data burst via the allocated resources.

In another example, a device for exchanging media data includes: a memory; and a processing system implemented in circuitry and configured to: receive a data burst size value for a data burst including packets of media data; determine a larger data burst size value that is larger than the received data burst size value; allocate resources to receive the data burst according to the larger data burst size value; and receive the data burst via the allocated resources.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for exchanging media data over a network.

FIG. 2 is a block diagram illustrating elements of an example video file.

FIG. 3 is a flow diagram illustrating an example method of using a ratio to modify a data burst value according to techniques of this disclosure.

FIG. 4 is a flow diagram illustrating an example method for over-provisioning resources for receiving a data burst per techniques of this disclosure.

FIG. 5 is a block diagram illustrating an example set of network devices that may perform various aspects of the techniques of this disclosure.

FIG. 6 is a flowchart illustrating an example method of calculating and sending data representing a ratio between an observed size of packets of a data burst per techniques of this disclosure.

FIG. 7 is a flowchart illustrating an example method of using a received ratio value to update a data burst size value of a subsequent data burst per techniques of this disclosure.

FIG. 8 is a flowchart illustrating an example method of allocating resources based on a signaled data burst size value per techniques of this disclosure.

### DETAILED DESCRIPTION

In general, this disclosure describes techniques for exchanging media data via a network. The network may be a 5G network, a 6G network, or other radio access network (RAN). A protocol data unit (PDU) set represents one or more PDUs each carrying a payload of a unit of information generated at the application level. Thus, for example, a PDU may include a frame of video data, a slice of a frame of video data, audio data, computer graphics data, or other media data for an extended reality (XR) service. 3GPP TS23.501 v.18.1.0 includes this definition of a PDU Set.

In addition to the PDU Set definition, 3GPP TS 23.501 defines a data burst as a set of multiple PDUs generated and sent by the application in a short period of time. Consequently, the techniques described herein for signaling data burst size may be performed in conjunction with normative work on related parameters, such as a Time to Next Burst (TTNB) and a Data Boosting Indication, to ensure accurate resource allocation.

When two (or more) devices are engaged in a communication session, one device may send a data burst size to another device, where the data burst size may represent the total size of packets included in the corresponding data burst, including RTP/UDP/IP header encapsulation overhead of the corresponding packets. A data burst may have a data burst size that is defined according to a cumulative size of all packets of the data burst (including both packet payloads and packet headers). Alternatively, the data burst size may be defined to only include the cumulative size of all packet payloads. In either case, various network operations or other circumstances may result in the data burst size as signaled not being accurate with respect to the observed data burst size at the destination device. Furthermore, some destination devices may be configured to calculate the cumulative size of all packets (including packet headers and packet payloads) when the source device is configured to signal only the cumulative size of all payloads as the data burst size, which may therefore be inaccurate.

An RTP (real-time transport protocol) sender may compute the data burst size value and include the data burst size value in an RTP header extension of an RTP packet sent to the RTP receiver. For example, the RTP sender may include the data burst size value in a GPRS Tunneling Protocol User Plane (GTP-U) packet header during GTP-U encapsulation at a user plane function (UPF), which may aid resource allocation for over-the-air transmissions. The data burst size value may include the size of the IP packet header and other packet headers.

Data burst size information may be passed via a router (which may execute a user plane function (UPF)) to a radio access network (RAN) to which a destination device is communicatively coupled, for scheduling over-the-air transmissions. The data burst size value may take account of sizes of IP packet headers, which may vary based on IP packet type (e.g., IPv4 uses IP packet headers of 20 bytes, whereas IPv6 uses IP packet headers of 40 bytes).

Certain issues may arise along a network route/path that may render a calculated data burst size value inaccurate. For example, network address translation (NAT), e.g., per NAT46/NAT64, and IP fragmentation may cause changes to received packets that render the initially calculated data burst size value inaccurate at the destination device and at a base station, such as gNodeB, to which the destination device is communicatively coupled via a RAN. In NAT46, for example, an incoming IP packet with IPv4 address is converted to an IP packet with IPv6 address, which results in a change in the total packet size because of the difference in the size of the IP packet header between IPv4 and IPv6. NAT64 is effectively the same issue in reverse.

Other operations that may result in data burst size value inaccuracies include IP fragmentation, where each increment in the number of IP packets adds an additional size worth of an IP packet header to the data burst size value, and Traversal Using Relays around NAT (TURN), where the TURN server may add a session traversal utilities for NAT (STUN) message header, a STUN attribute, and a transport address. There are other such operations as well, and more operations may be developed in the future that alter the data burst size value.

This disclosure describes various techniques that may be used to mitigate differences between a signaled data burst size value and an actual size for the data burst as received. In some examples, a destination device may measure the actual size for the data burst as received and signal data that may be used to correct the difference between the signaled data burst size and the actual data size to the source device.

As another example, a base station that uses the signaled burst size value to allocate resources for data reception may over-provision such resources based on the signaled burst size value. For low-latency applications, such as split-rendering of XR media data, it may be beneficial to over-provision these resources for the indicated burst size, because otherwise, if the allocated resources are not sufficient, delays may result from insufficient resources for serving the data burst. In some examples, over-provisioning may be triggered by a source device calculating an expected data burst size value, then signaling a larger data burst size value. In some examples, over-provisioning may be triggered by a router executing a UPF, which may signal a larger data burst size value in a GTP-U header than the data burst size value signaled by the source device.

In this manner, the techniques of this disclosure may result in a more accurate data burst size value and/or provisioning of resources sufficient to receive the data burst. These techniques may therefore avoid loss of data transmissions, which may reduce latency, transmission resources being consumed for retransmission, and improve the experience of a user participating in a data communication session.

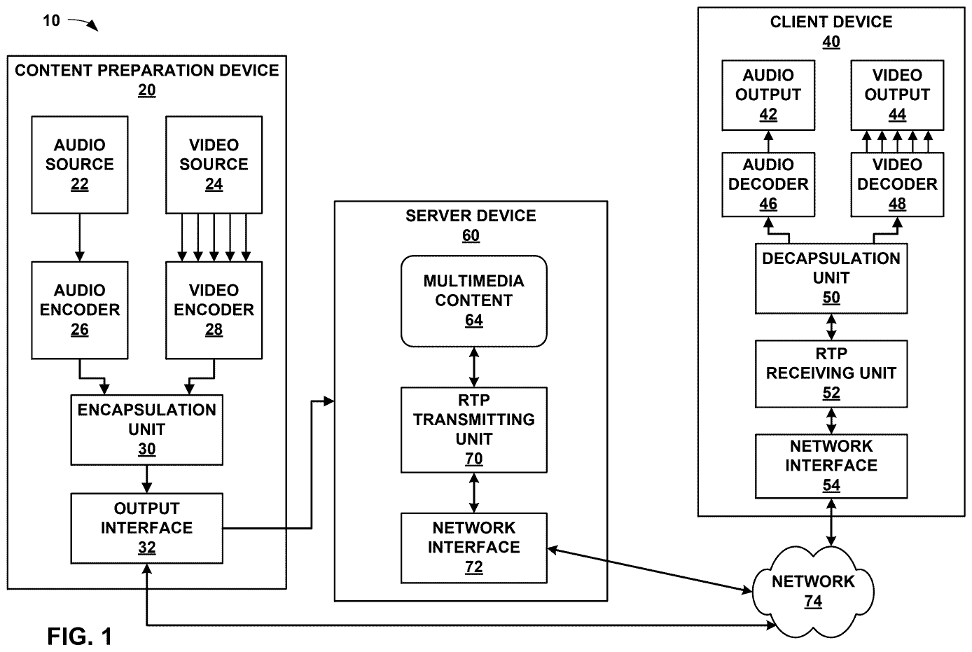

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device. Network 74 may include various network elements, such as routers, a User Plane Function (UPF), and a Radio Access Network (RAN), that may alter the size of packets, for example through network address translation (NAT) or by adding tunnel headers.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multiview Video Coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

In accordance with the techniques of this disclosure, system 10 may correct for inaccuracies in data burst size. Server device 60 may initially determine a data burst size value for a data burst, e.g., based on a number of packets included in the data burst, IP, UDP, and RTP header sizes for each of the packets (e.g., based on an IP version used, e.g., IPv4 or IPv6), payload sizes for the packets, and so on. RTP transmitting unit 70 may signal the data burst value in an RTP extension header of packets for the data burst.

Network interface 54 may include additional sub-units (not shown in FIG. 1). For example, network interface 54 may include sub-units for processing each layer of the OSI Network Model, e.g., layer 1, layer 2, layer 3, and so on. A unit at layer 3 (the transport layer) may be configured to perform certain techniques of this disclosure. For example, the unit at layer 3 (referred to hereafter as the “Layer 3 unit”) may receive packets of a data burst. Prior to performing IP packet reassembly if the packets are fragmented, the Layer 3 unit may calculate a total cumulative size of IP packets belonging to a common data burst. This total cumulative size may be denoted “data_burst_size_actual.” The Layer 3 unit may also extract the signaled data burst size of the data burst, which may be denoted “data_burst_size_signaled.”

The Layer 3 unit may then calculate a ratio for the data burst, e.g., ratio (r)=data_burst_size_actual/data_burst_size_signaled. The Layer 3 unit may calculate such ratios for all or a subset of the data bursts of a media session. If packet loss occurs, the Layer 3 unit may be configured to calculate ratios only for data bursts whose packets are completely received.

The Layer 3 unit may pass the ratio to the application layer (e.g., a Media Session Handler (MSH), not shown in FIG. 1), or to the RTP layer (handled by RTP receiving unit 52). RTP receiving unit 52 may then compare the ratio to a threshold or range (which may have been advertised/signaled in an RTP extension header or in media session configuration information). The range may be, for example [−0.95, +1.05]. If the ratio exceeds the threshold or is outside of the range, RTP receiving unit 52 may signal the ratio to server device 60 and/or content preparation device 20. For example, RTP receiving unit 52 may send a session description protocol (SDP) update message, a real-time transport protocol (RTP) control protocol (RTCP) message, a Simple WebRTC Application Protocol (SWAP) message, an RTP header extension, or the like, indicative of the ratio.

When sending the message as an RTCP message, the message may be, for example, an RTCP transport layer feedback message, an RTCP payload specific feedback message, or an RTCP application layer feedback message, with the general framework as defined in Ott et al., “Extended RTP Profile for Real-time Transport Control Protocol (RTCP)-based Feedback (RTP/AVPF),” Network Working Group, RFC 4585, July 2006, available at www.rfc-editor.org/rfc/rfc4585.html. Alternatively, the RTCP message may be an RTCP application specific message with the general framework defined in Schulzrinne et al., “RTP: A Transport Protocol for Real-Time Applications,” Network Working Group, RFC 3550, July 2003, available at datatracker.ietf.org/doc/html/rfc3550. Alternatively, the RTCP message may be an RTCP extended report with the general framework defined in Foster et al., “Media Gateway Control Protocol (MGCP) Return Code Usage,” Network Working Group, RFC 3661, December 2003, available at datatracker.ietf.org/doc/html/rfc3661.

SWAP is a protocol for control signaling for WebRTC and is further defined in 3GPP, “Real-Time Media Communication; Protocols and APIs,” 3GPP TS 26.113 v18.1.0, Release 18, Oct. 2, 2024, available at portal.3gpp.org/desktopmodules/Specifications/SpecificationDetails.aspx? specificationId=4041. A SWAP message may contain a source identifier (ID), a message ID, a message type (e.g., “connect,” “accept,” “update,” “reject,” “close,” or “application”), and a message (e.g., an SDP Offer.)

In this manner, the correction may be based on the ratio (also referred to as the “correction ratio”) of the observed size of a data burst to an indicated size for the data burst. The corrected size for a subsequent data burst may be equal to the size for the subsequent data burst without the feedback multiplied by the correction ratio.

As such, when server device 60 receives data representing such a ratio from client device 40, server device 60 may update the signaled data burst size value for a subsequent data burst according to the ratio. For example, if server device 60 calculates a new data burst size value for the subsequent data burst by the same method as was previously used to calculate the previous data burst size value, server device 60 may then update the new data burst size value according to the received ratio value. For example, if the new data burst size value is p and the ratio is r, server device 60 may update the new data burst size value to be equal to p*r. Thus, receipt of a ratio value may trigger pre-compensation by server device 60 in this manner. That is, pre-compensation may be computation of an updated data burst size value using the ratio value received from client device 40.

The calculation and application of the correction ratio may directly address inaccuracies in the signaled data burst size that can arise from network operations, such as packet fragmentation. Operations such as network address translation (e.g., NAT46 or NAT64) that change IP header sizes, or IP fragmentation that adds extra headers, can cause the actual size of the data burst received at client device 40 to differ from the size signaled by server device 60. The ratio feedback mechanism allows server device 60 to determine the extent of this difference and pre-compensate subsequently signaled burst size values accordingly.

As another example, in addition or in the alternative to the correction ratio signaling and pre-compensation techniques above, server device 60 or a device (e.g., a router) executing a UPF, may be configured to perform over-provisioning to handle data burst size value inaccuracies. For example, server device 60 may be configured to enable over-provisioning in downstream routers, e.g., a router executing a UPF or a router of the RAN to which client device 40 is connected. These techniques for source-initiated over-provisioning may be implemented in accordance with 5G Real-time Media Transport Protocol Configurations, such as those defined in 3GPP TS 26.522. To enable over-provisioning, server device 60 may calculate an initially calculated data burst size for a data burst, then signal a signaled data burst size for the data burst that is larger than the calculated data burst size (either with or without data burst size correction, e.g., using the ratio discussed above). The downstream routers may then allocate resources for receiving the data burst according to the indicated burst size. As another example, the router executing the UPF may extract a signaled data burst size value from, e.g., an RTP header extension of the data burst, then signal a larger data burst size value in a GTP-U packet header encapsulating the packets of the data burst.

In the source-initiated over-provisioning approach, server device 60 may calculate an initial data burst size value based on the packets to be sent. Server device 60 may then determine a signaled data burst size value that is intentionally larger than this calculated initial value. This determination may follow a predefined rule or a dynamic policy. By signaling this larger value in the data burst sent to client device 40, server device 60 may preemptively request more network resources via downstream entities (like a UPF or RAN), aiming to better ensure sufficient capacity even if network operations increase the actual burst size en route or to meet low-latency requirements.

The larger data burst size value may be determined by a preset rule. Alternatively, the larger data burst size value may be determined according to a dynamic policy, e.g., per a protocol description sent from a policy and control function (PCF) based on signaling from a traffic source (e.g., content preparation device 20) or a destination (e.g., client device 40).

The over-provisioning techniques, whether initiated by server device 60, a UPF device, or directly at a RAN, may be beneficial for low-latency applications, such as split-rendering extended reality (XR) media data. For such applications, ensuring that allocated resources are sufficient to handle the entire data burst without delay can be important for a good user experience. Over-provisioning may help to mitigate the risk of delays caused by needing to allocate additional resources mid-burst if the actual burst size exceeds the initially signaled size.

As still another example, in addition to or in the alternative to the various techniques discussed above, the base station of the RAN to which client device 40 is communicatively coupled may be configured to allocate resources according to a larger data burst size value than that signaled for the data burst.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

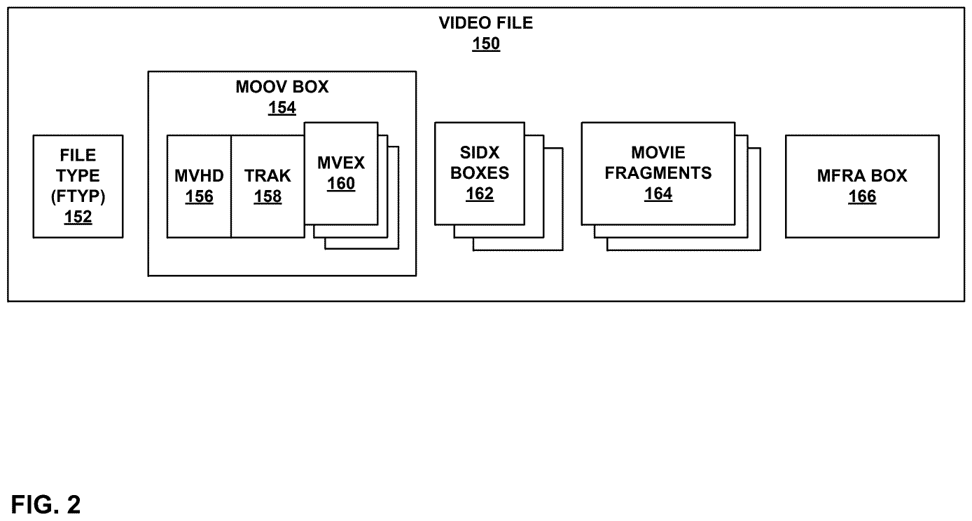

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

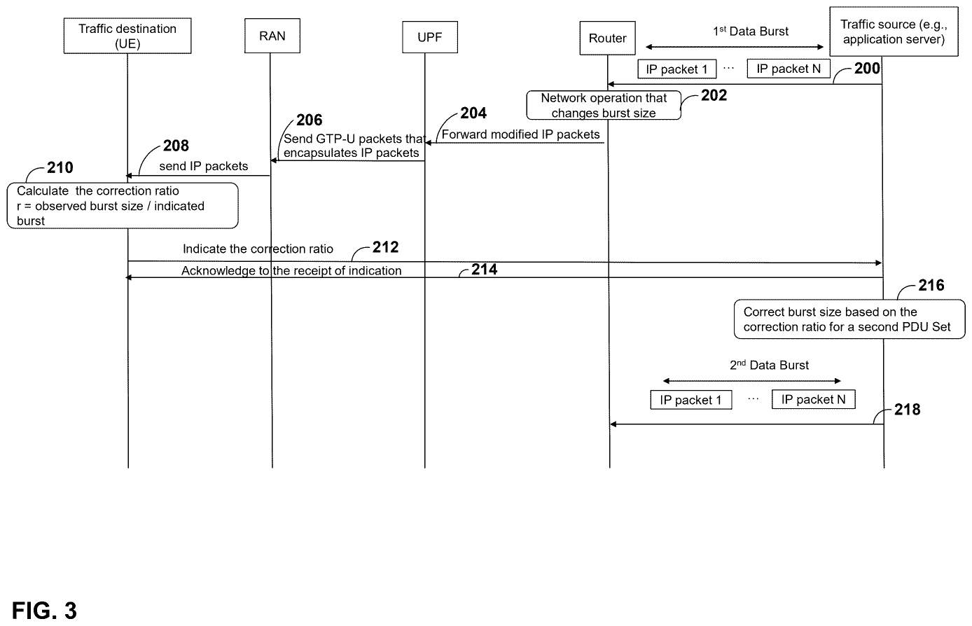

FIG. 3 is a flow diagram illustrating an example method of using a ratio to modify a data burst value according to techniques of this disclosure. In this example, initially, a traffic source device (such as an application server (AS), e.g., server device 60 of FIG. 1) receives a first plurality of packets to be sent in a first data burst and determines a burst size value for the first data burst including the first plurality of packets including media data or other data. The traffic source device sends the data burst toward a traffic destination device, such as a user equipment (UE) device (e.g., client device 40 of FIG. 1), including data representing the burst size value (200). In particular, the traffic source may determine a larger initial burst size value for the first data burst, e.g., according to a predefined rule or a dynamic policy and signal the larger initial burst size value for the first data burst. A router or other network device receives the packets of the first data burst and performs an operation that changes the burst size (202), e.g., fragmentation, network address translation (NAT), or the like. The router forwards the modified packets to a device that executes a user plane function (UPF) (204).

The device that executes the UPF may encapsulate the packets of the first data burst into tunneled packets, e.g., GTP-U packets. The device that executes the UPF may forward the tunneled packets via a network tunnel to reach a base station of a radio access network (RAN) (206). The base station may then use the data burst size value to allocate resources for receiving the packets, then forward the packets to the traffic destination device (208), e.g., client device 40 of FIG. 1.

The traffic destination device may extract the signaled data burst size value for the data burst and calculate an actual data burst size for the data burst. The traffic destination device may then calculate a ratio (r) between the actual data size and the signaled data burst size value (210). The traffic destination may send data representing the ratio to the traffic source device (212), and the traffic source device may acknowledge receipt of the ratio (214).

Calculating the ratio (r) between the actual, observed data size (cumulative size) and the signaled data burst size value allows the traffic destination device to quantify the impact of network operations that may have altered the burst size during transit. Sending data representative of this ratio back to the traffic source device provides feedback enabling the source device to adjust subsequent burst size signaling. This correction mechanism, where the traffic source device applies the received ratio to pre-compensate the calculated size for a subsequent data burst, may make the signaled burst size more accurately reflect the size eventually received by the destination device, which may improve resource allocation efficiency in the RAN.

The traffic source device may then use the ratio to correct a data burst size for a second data burst including a second plurality of packets (216). For example, the traffic source device may calculate a size of the second data burst in the same manner as the first data burst. However, the traffic source device may then apply the ratio to the calculated size of the second data burst to determine a corrected data burst size, then signal the corrected data burst size for the second data burst and send the second data burst toward the traffic destination (218).

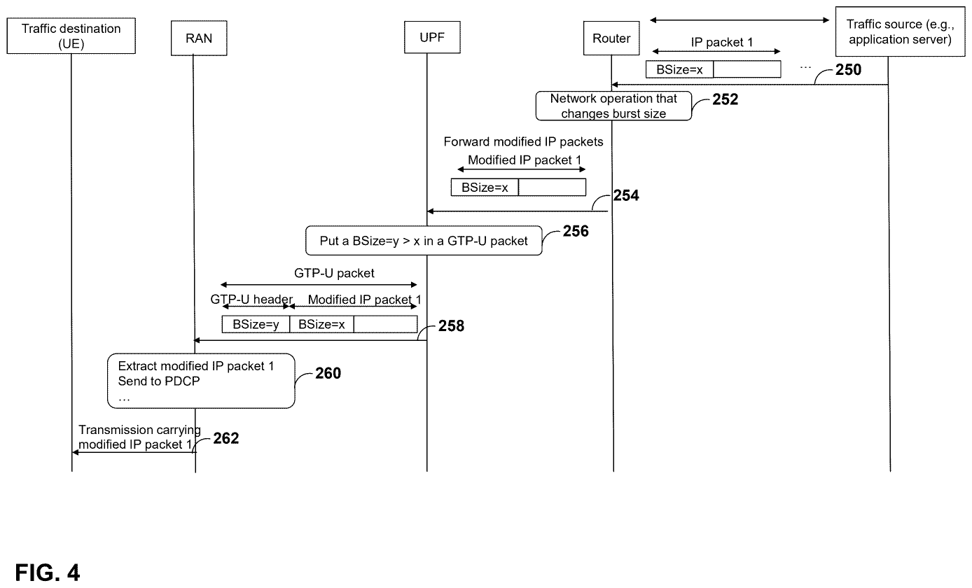

FIG. 4 is a flow diagram illustrating an example method for over-provisioning resources for receiving a data burst per techniques of this disclosure. Initially, in this example, a traffic source (e.g., an application server (AS), such as server device 60 of FIG. 1) signals a data burst size (BSize) for a set of packets of a data burst. The traffic source then sends packets of the data burst to a traffic destination (e.g., a user equipment (UE) device, such as client device 40 of FIG. 1) (250). A router along a network route between the traffic source and the traffic destination performs one or more network operations that modify IP packets of the data burst (252), such as NAT, packet fragmentation, or the like. The router forwards the modified packets along the network route to a device that executes a UPF (254).

The device that executes the UPF, in this example, performs over-provisioning. That is, the device that executes the UPF determines the signaled BSize value for the data burst, then encapsulates the packets of the data burst into tunneled packets (e.g., GTP-U packets), and signals a BSize value (y) in a tunnel header of the tunneled packets that is larger than the originally signaled BSize value (x), i.e., y>x (256). The device that executes the UPF then forwards the packets of the data burst along the network tunnel to reach a base station of a RAN (258).

This example illustrates over-provisioning initiated by the device executing the UPF. By determining the signaled BSize value (x) arriving from the traffic source and then signaling a larger BSize value (y) in the tunnel header (e.g., GTP-U header) towards the RAN (256), the UPF device may effectively instruct the RAN to allocate more resources than originally indicated by the source device. This deliberate over-provisioning at the UPF device can compensate for potential burst size increases occurring upstream or downstream due to network operations, or to support quality of service requirements for applications sensitive to delay, such as split-rendering XR, by mitigating risks of insufficient resource allocation at the RAN. The determination of the larger value (y) may be based on a preset rule configured at the UPF device or derived from a dynamic policy received, for example, from a policy control function (PCF) based on signaling from the traffic source or destination.

The base station may then use the BSize value signaled in the tunnel header to perform resource allocation for receiving the packets of the data burst (260). That is, the base station may perform resource allocation as if the signaled data burst size is y, rather than x, where y>x. In this manner, the base station may over-provision resources for receiving the packets of the data burst. The base station may then receive the packets of the data burst using the allocated resources, extract packets from the received tunneled packets, and forward the packets to the traffic destination device (262).

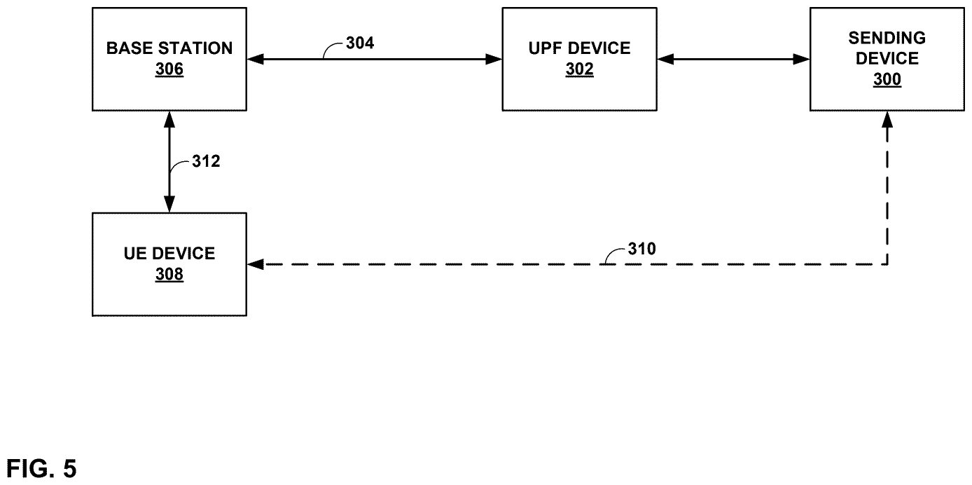

FIG. 5 is a block diagram illustrating an example set of network devices that may perform various aspects of the techniques of this disclosure. The example of FIG. 5 depicts sending device 300, user plane function (UPF) device 302, base station 306, and user equipment (UE) device 308. Sending device 300 may correspond to content preparation device 20 or server device 60 of FIG. 1. UE device 308 may correspond to client device 40 of FIG. 1. In some examples, sending device 300 may also be a UE device, and both sending device 300 and UE device 308 may be configured to both send and receive media data, e.g., as part of a media communication session (e.g., a voice or video call).

Sending device 300 (e.g., an application server (AS) device or another UE device) may obtain video data to be sent to UE device 308 via communication session 310. To send the video data to UE device 308, sending device 300 may encode the video data (or receive encoded video data from an encoding device, not shown in FIG. 5). Sending device 300 may encapsulate packets including encoded video data (e.g., encoded slices of frames of video data) to form real-time transport protocol (RTP) packets. Such RTP packets may correspond to PDUs of respective data bursts.

Sending device 300 may add an RTP header extensions to certain PDUs to indicate burst size data for a current data burst. For example, sending device 300 may add such RTP header extensions to ordinal first PDUs and/or to PDUs indicating a burst size update for the current data burst. As the RTP packets are formed, sending device 300 may send the RTP packets to UE device 308 via a network including UPF device 302. Although not shown in FIG. 5, there may be additional network devices between sending device 300 and UPF device 302, e.g., various network routing devices, gateways, bridges, switches, or the like.

Per techniques of this disclosure, sending device 300 may initially determine a data burst size from a size of packets or data to be sent as part of the data burst, including sizes of packet headers to be used to form the packets. Sending device 300 may further determine a data burst size value to be signaled, which may be larger than the initially determined data burst size. For example, sending device 300 may calculate the data burst size value to be signaled according to a predefined rule or according to a dynamic policy.

UPF device 302 may receive the RTP packets from sending device 300 and form GTP-U tunneled packets. For example, UPF device 302 may encapsulate the RTP packets with respective GTP-U headers. UPF device 302 may extract the burst size data and accuracy data from the RTP header extensions of the RTP packets, e.g., from respective RTP header extensions. UPF device 302 may then form the GTP-U headers to include corresponding burst size data and accuracy data. UPF device 302 may send the GTP-U packets to base station 306 via network tunnel 304. Network tunnel 304 may include other network devices, such as network routing devices, configured to forward the GTP-U packets along network tunnel 304 to base station 306. In some cases, UPF device 302 may need to fragment packets of the data burst, e.g., divide one or more packets into one or more smaller packets, e.g., to fit within a maximum transmission unit (MTU) size. Additionally or alternatively, a device between sending device 300 and UPF device 302 (e.g., a router) may fragment the packets into smaller packets.

Base station 306 may receive the GTP-U packets and decapsulate the GTP-U packets to reproduce the RTP packets. Base station 306 may allocate resources to reception of the GTP-U packets based on the burst size data and accuracy data signaled in the GTP-U header. For example, base station 306 may instruct UE device 308 to disable data reception after the total amount of data corresponding to the burst size for the current data burst has been received for a period of time corresponding to a signaled time to next burst. Base station 306 may then send the RTP packets to UE device 308 via radio access network (RAN) connection 312.

In some examples, per techniques of this disclosure, base station 306 may also calculate a cumulative total size of packets received for a current data burst. After receiving all packets of the current data burst, base station 306 may calculate a ratio of the cumulative total size of the packets of the data burst and the signaled data burst size. Base station 306 may then send data representative of the ratio to sending device 300. For example, the data representative of the ratio may be data directly representing the ratio or data representing an amount by which to adjust the signaled data burst size to achieve the calculated data burst size.

UE device 308 may receive the RTP packets from base station 306 via RAN connection 312. In particular, UE device 308 may be a battery powered device, such as a cellphone. Thus, to preserve battery power, UE device 308 may disable reception of packets for communication session 310 via RAN connection 312 for idle period times indicated by the TNBD/TTNB values following reception of all data for the current data burst as indicated by the burst size data and accuracy data. For example, during idle period times, UE device 308 may power down reception circuitry, then power up the reception circuitry at the end of the idle period.

In some examples, per techniques of this disclosure, UE device 308 may (in addition or in the alternative to base station 306) calculate a cumulative total size of packets received for a current data burst. After receiving all packets of the current data burst, UE device 308 may calculate a ratio of the cumulative total size of the packets of the data burst and the signaled data burst size. UE device 308 may then send data representative of the ratio to sending device 300. For example, the data representative of the ratio may be data directly representing the ratio or data representing an amount by which to adjust the signaled data burst size to achieve the calculated data burst size.

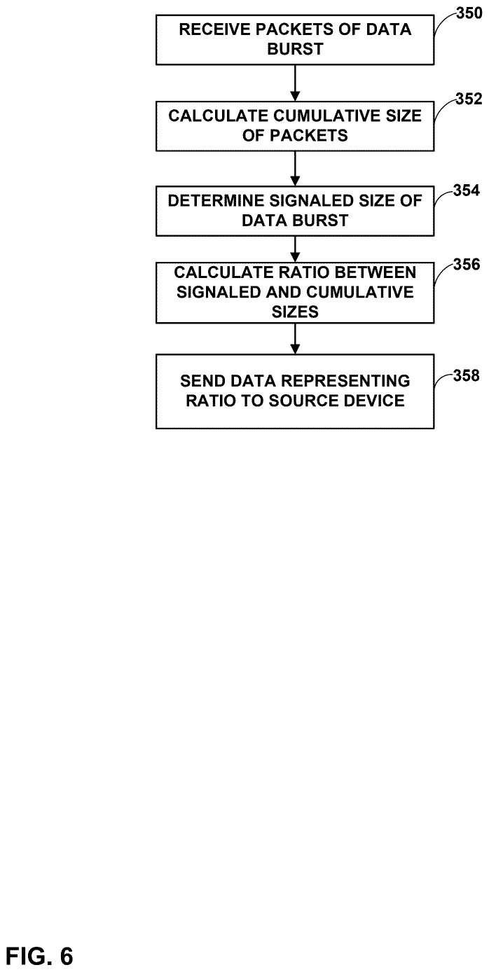

FIG. 6 is a flowchart illustrating an example method of calculating and sending data representing a ratio between an observed size of packets of a data burst per techniques of this disclosure. The method of FIG. 6 may be performed by a device that receives media data via a communication session, e.g., client device 40 of FIG. 1 or UE device 308 or base station 306 of FIG. 5. For purposes of example and explanation, the method of FIG. 6 is explained with respect to UE device 308 of FIG. 5.

Initially, UE device 308 may receive packets of a current data burst of a media communication session (350). For example, UE device 308 and sending device 300 may establish a media communication session by which sending device 300 sends data bursts to UE device 308 via, e.g., a user plane function (UPF), such as UPF device 302 of FIG. 5, which may send tunneled packets to UE device 308 via a network tunnel that communicatively couples UPF device 302 to a base station, such as base station 306 (e.g., a gNB).

UE device 308 may calculate a cumulative size of the received packets of the data burst (352), including packet headers as well as packet payloads. UE device 308 may also determine a signaled size of the data burst (354). For example, UE device 308 may determine the size of the data burst from an RTP header extension of one or more of the packets of the data burst. UE device 308 may then calculate a ratio between the signaled size for the data burst and the calculated cumulative size for the packets of the data burst (356).

UE device 308 may then send data representing the ratio to the source device, e.g., sending device 300 (358). In some examples, UE device 308 may determine whether to send the data representative of the ratio. For example, UE device 308 may determine to send data representative of the ratio if the ratio exceeds a threshold or is outside of a defined range. Sending device 300 may send configuration data indicative of the threshold or defined range. Thus, UE device 308 may determine to send the data representative of the ratio when the ratio does not exceed the threshold or is outside of the defined range. In some examples, the data representative of the ratio may be a raw value of the ratio. In some examples, the data representative of the ratio may be an amount by which the signaled size needs to be adjusted to achieve a target ratio between the cumulative size and the signaled size.

In this manner, the method of FIG. 6 represents an example of a method of exchanging media data including calculating a cumulative size of packets of a data burst received from a source device, the packets including media data; determining a signaled data burst size for the data burst; calculating a ratio between the cumulative size and the signaled size; and sending data representative of the ratio to the source device.

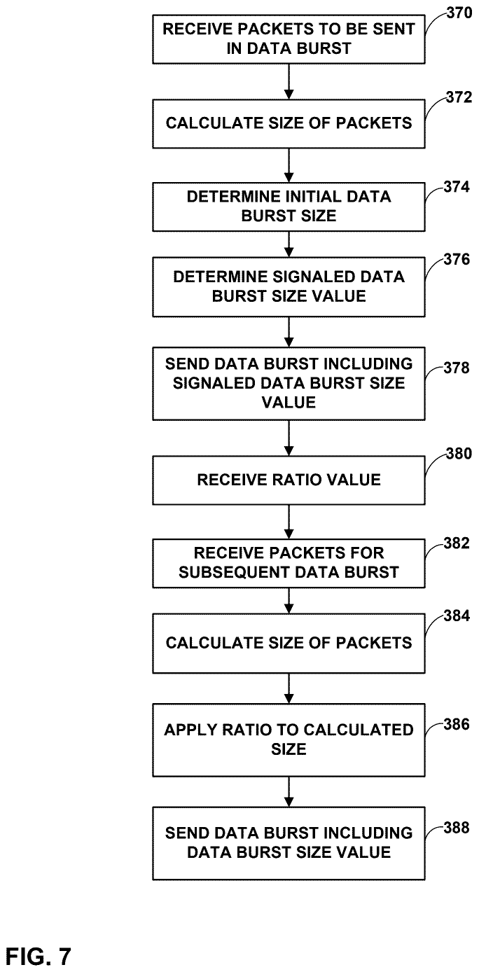

FIG. 7 is a flowchart illustrating an example method of using a received ratio value to update a data burst size value of a subsequent data burst per techniques of this disclosure. The method of FIG. 7 may be performed by a source device, such as content preparation device 20 or server device 60 of FIG. 1 or sending device 300 of FIG. 5. For purposes of explanation, the method of FIG. 7 is described with respect to sending device 300.

Initially, sending device 300 receives packets to be sent in a first data burst (370). Sending device 300 calculates a size of the packets (372) and determines an initial data burst size for the first data burst (374). Sending device 300 also determines a signaled data burst size value (376). Sending device 300 may determine the signaled data burst size value according to a predefined rule or a dynamic policy.

Sending device 300 sends the first data burst, including the signaled data burst size value, toward a destination device (378). Subsequently, sending device 300 receives a ratio value from the destination device (380). The ratio value may represent a correction ratio based on a cumulative size of the packets as observed by the destination device compared to the signaled data burst size value, e.g., as described with respect to FIG. 6.

Sending device 300 later receives packets for a subsequent data burst (382). Sending device 300 may calculate a size of the packets for the subsequent data burst (384). To pre-compensate for network operations that may alter packet sizes, in this example, sending device 300 applies the received ratio to the calculated size of the subsequent data burst (386). This calculation produces a corrected data burst size value. Sending device 300 then sends the subsequent data burst, including the corrected data burst size value, to the destination device (388). Using these techniques, sending device 300 may adjust signaled burst sizes based on measured feedback to account for inaccuracies introduced by network elements, such as routers that perform packet fragmentation.

In this manner, the method of FIG. 7 represents an example of a method of exchanging media data including: determining an initial data burst size value for a data burst including packets including media data; signaling a signaled data burst size value for the data burst, the signaled data burst size value being larger than the initial data burst size value; and sending the data burst including the signaled data burst size value to a destination device.

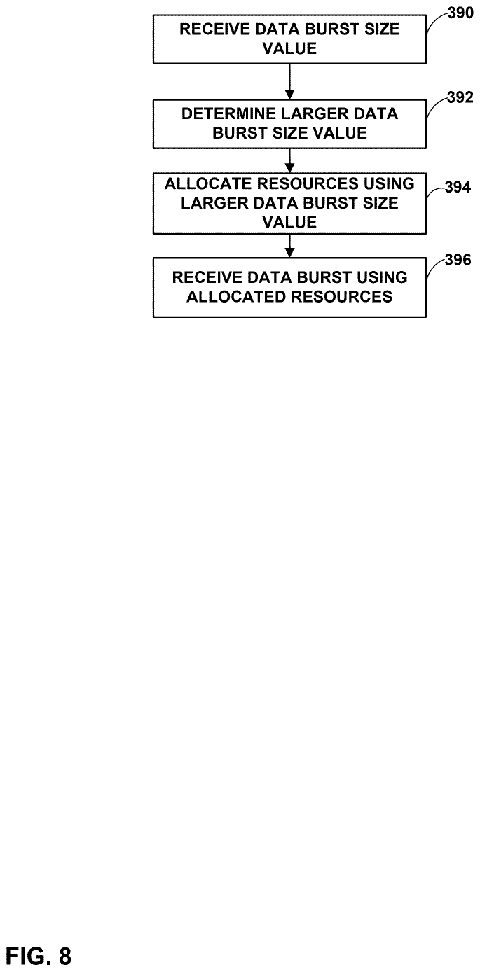

FIG. 8 is a flowchart illustrating an example method of allocating resources based on a signaled data burst size value per techniques of this disclosure. The method of FIG. 8 may be performed by a network device within a radio access network (RAN), for example, base station 306 of FIG. 5. This or a similar method may, additionally or alternatively, be performed by other devices configured to perform overprovisioning, such as UPF device 302 of FIG. 5. This method enables over-provisioning directly at the RAN to handle potential inaccuracies in the signaled data burst size.

Initially, base station 306 receives a data burst size value for an incoming data burst (390). This signaled value may be received, for example, within a tunnel header (such as a GTP-U header) from an upstream network entity, such as UPF device 302, or based on signaling originating from sending device 300 (e.g., in an RTP header extension).

Base station 306 determines a larger data burst size value that is greater than the received, signaled data burst size value (392). Determining this larger value may be performed to proactively compensate for potential inaccuracies in the signaled size caused by network operations (such as NAT or fragmentation) or to ensure sufficient resource allocation for low-latency applications, thereby reducing potential delays if the actual burst size exceeds the signaled size.

Base station 306 allocates radio resources for receiving the data burst according to the determined larger data burst size value, rather than the originally received signaled value (394). Allocating based on the larger value may help to ensure that sufficient resources are available even if the actual data burst size is larger than initially indicated.

Base station 306 receives the packets of the data burst using the allocated resources (396). After receiving the data burst via the over-provisioned resources, base station 306 may forward the packets of the data burst to the destination device, such as UE device 308.

In this manner, the method of FIG. 8 represents an example of a method of exchanging media data, including: determining an initial data burst size value for a data burst including packets including media data; signaling a signaled data burst size value for the data burst, the signaled data burst size value being larger than the initial data burst size value; and sending the data burst including the signaled data burst size value to a destination device.

Various examples of the techniques of this disclosure are summarized in the following clauses:

Clause 1: A method of exchanging media data, the method comprising: calculating a cumulative size of packets of a data burst received from a source device, the packets including media data; determining a signaled data burst size for the data burst; calculating a ratio between the cumulative size and the signaled size; and sending data representative of the ratio to the source device.

Clause 2: The method of clause 1, further comprising determining to send the data representative of the ratio to the source device based on the ratio.

Clause 3: The method of any of clauses 1 and 2, wherein sending the data representative of the ratio comprises: determining that the ratio exceeds at least one threshold; and in response to the determination that the ratio exceeds the at least one threshold, sending the data representative of the ratio to the source device.

Clause 4: The method of clause 3, further comprising receiving data defining the at least one threshold from the source device.

Clause 5: The method of any of clauses 1-4, wherein sending the data representative of the ratio comprises: determining that the ratio is not within a defined range; and in response to the determination that the ratio is not within the defined range, sending the data representative of the ratio to the source device.

Clause 6: The method of clause 5, further comprising receiving data defining the defined range from the source device.

Clause 7: The method of any of clauses 1-6, wherein the data representative of the ratio comprises data explicitly indicating the ratio.

Clause 8: The method of any of clauses 1-7, wherein the data representative of the ratio comprises data indicating an amount by which the signaled size needs to be adjusted to achieve a target ratio between the cumulative size and the signaled size.

Clause 9: The method of clause 8, further comprising: determining that the amount by which the signaled size needs to be adjusted exceeds at least one threshold; and in response to the determination that the amount by which the signaled size needs to be adjusted exceeds the at least one threshold, sending the data representative of the amount by which the signaled size needs to be adjusted to the source device.

Clause 10: The method of clause 8, further comprising: determining that the amount by which the signaled size needs to be adjusted is not within a defined range; and in response to determining that the amount by which the signaled size needs to be adjusted is not within the defined range, sending the data representative of the amount by which the signaled size needs to be adjusted to the source device.

Clause 11: The method of any of clauses 1-10, wherein sending the data representative of the ratio comprises sending at least one of a Session Description Protocol (SDP) update message, a real-time transport protocol (RTP) control protocol (RTCP) message, a simple WebRTC Application Protocol (SWAP) message, or an RTP header extension including the data representative of the ratio to the source device.

Clause 12: The method of any of clauses 1-11, further comprising performing IP packet reassembly of the packets of the data burst, wherein calculating the cumulative size of the packets comprises calculating the cumulative size of the packets before performing the IP packet reassembly of the packets of the data burst.

Clause 13: The method of any of clauses 1-12, wherein the method is performed by a unit that performs OSI Model Layer 3 processing on packets, the method further comprising providing the ratio to a Media Session Handler (MSH).

Clause 14: A method of exchanging media data, the method comprising: determining an initial data burst size value for a data burst including packets including media data; signaling a data burst size value for the data burst, the signaled data burst size value being larger than the initial data burst size value; and sending the data burst including the signaled data burst size value to a destination device.

Clause 15: A method comprising a combination of the method of any of clauses 1-13 and the method of clause 14.

Clause 16: The method of any of clauses 14 and 15, wherein determining the initial data burst comprises calculating a size of the packets of the data burst.

Clause 17: The method of any of clauses 14 and 15, wherein determining the initial data burst comprises extracting a signaled data burst size for the data burst, and wherein signaling comprises: encapsulating each of the packets of the data burst into tunneled network packets having a tunnel header; and signaling the signaled data burst size value in the tunnel header.

Clause 18: The method of any of clauses 14-17, further comprising determining the signaled data burst size value according to a predefined rule.

Clause 19: The method of any of clauses 14-17, further comprising: receiving data representative of a dynamic policy for determining the signaled data burst size value; and determining the signaled data burst size value according to the dynamic policy.

Clause 20: A device for exchanging media data, the device comprising one or more means for performing the method of any of clauses 1-19.

Clause 21: The device of clause 20, wherein the one or more means comprise a processing system implemented in circuitry.

Clause 22: The device of clause 21, wherein the device comprises at least one of: an integrated circuit; a microprocessor; or a wireless communication device.

Clause 23: A computer-readable storage medium having stored thereon instructions that, when executed, cause a processing system to perform the method of any of clauses 1-19.

Clause 24: A device for exchanging media data, the device comprising: means for calculating a cumulative size of packets of a data burst received from a source device, the packets including media data; means for determining a signaled data burst size for the data burst; means for calculating a ratio between the cumulative size and the signaled size; and means for sending data representative of the ratio to the source device.

Clause 25: A device for exchanging media data, the device comprising: means for determining an initial data burst size value for a data burst including packets including media data; means for signaling a data burst size value for the data burst, the signaled data burst size value being larger than the initial data burst size value; and means for sending the data burst including the signaled data burst size value to a destination device.

Clause 26: The device of clause 25, wherein the device comprises a server device.

Clause 27: The device of clause 25, wherein the device comprises a source device.

Clause 28: The device of clause 25, wherein the device comprises a router that executes a user plane function (UPF).

Clause 29: A method of exchanging media data, the method comprising: receiving a data burst size value for a data burst including packets of media data; determining a larger data burst size value that is larger than the received data burst size value; allocating resources for receiving the data burst according to the larger data burst size value; and receiving the data burst via the allocated resources.

Clause 30: The method of clause 29, further comprising sending the received data burst to a client device via a radio access network (RAN).

Clause 31: A device for exchanging media data, the device comprising one or more means for performing the method of any of clauses 29 and 30.

Clause 32: The device of clause 31, wherein the one or more means comprise a processing system implemented in circuitry.

Clause 33: A device for exchanging media data, the device comprising: means for receiving a data burst size value for a data burst including packets of media data; means for determining a larger data burst size value that is larger than the received data burst size value; means for allocating resources for receiving the data burst according to the larger data burst size value; and means for receiving the data burst via the allocated resources.

Clause 34: A method of exchanging media data, the method comprising: calculating a cumulative size of packets of a data burst received from a source device, the packets including media data; determining a signaled data burst size for the data burst; calculating a ratio between the cumulative size and the signaled size; and sending data representative of the ratio to the source device.

Clause 35: The method of clause 34, further comprising determining to send the data representative of the ratio to the source device based on the ratio.

Clause 36: The method of any of clauses 34 and 35, wherein sending the data representative of the ratio comprises: determining that the ratio exceeds at least one threshold; and in response to the determination that the ratio exceeds the at least one threshold, sending the data representative of the ratio to the source device.

Clause 37: The method of clause 36, further comprising receiving data defining the at least one threshold from the source device.

Clause 38: The method of any of clauses 34-37, wherein sending the data representative of the ratio comprises: determining that the ratio is not within a defined range; and in response to the determination that the ratio is not within the defined range, sending the data representative of the ratio to the source device.

Clause 39: The method of clause 38, further comprising receiving data defining the defined range from the source device.

Clause 40: The method of any of clauses 34-39, wherein the data representative of the ratio comprises data explicitly indicating the ratio.

Clause 41: The method of any of clauses 34-39, wherein the data representative of the ratio comprises data indicating an amount by which the signaled size needs to be adjusted to achieve a target ratio between the cumulative size and the signaled size.

Clause 42: The method of clause 41, further comprising: determining that the amount by which the signaled size needs to be adjusted exceeds at least one threshold; and in response to the determination that the amount by which the signaled size needs to be adjusted exceeds the at least one threshold, sending the data representative of the amount by which the signaled size needs to be adjusted to the source device.

Clause 43: The method of clause 41, further comprising: determining that the amount by which the signaled size needs to be adjusted is not within a defined range; and in response to determining that the amount by which the signaled size needs to be adjusted is not within the defined range, sending the data representative of the amount by which the signaled size needs to be adjusted to the source device.

Clause 44: The method of any of clauses 34-43, wherein sending the data representative of the ratio comprises sending at least one of a Session Description Protocol (SDP) update message, a real-time transport protocol (RTP) control protocol (RTCP) message, a simple WebRTC Application Protocol (SWAP) message, or an RTP header extension including the data representative of the ratio to the source device.

Clause 45: The method of any of clauses 34-44, further comprising performing IP packet reassembly of the packets of the data burst, wherein calculating the cumulative size of the packets comprises calculating the cumulative size of the packets before performing the IP packet reassembly of the packets of the data burst.

Clause 46: The method of any of clauses 34-45, wherein the method is performed by a unit that performs OSI Model Layer 3 processing on packets, the method further comprising providing the ratio to a Media Session Handler (MSH).

Clause 47: A device for exchanging media data, the device comprising: a memory; and a processing system implemented in circuitry and configured to: calculate a cumulative size of packets of a data burst received from a source device, the packets including media data; determine a signaled data burst size for the data burst; calculate a ratio between the cumulative size and the signaled size; and send data representative of the ratio to the source device.

Clause 48: The device of clause 47, wherein to send the data representative of the ratio, the processing system is further configured to: determine that the ratio exceeds at least one threshold; and in response to the determination that the ratio exceeds the at least one threshold, send the data representative of the ratio to the source device.

Clause 49: The device of clause 47, wherein to send the data representative of the ratio, the processing system is further configured to: determine that the ratio is not within a defined range; and in response to the determination that the ratio is not within the defined range, send the data representative of the ratio to the source device.

Clause 50: The device of any of clauses 47-49, wherein the data representative of the ratio comprises data explicitly indicating the ratio.

Clause 51: The device of any of clauses 47-49, wherein the data representative of the ratio comprises data indicating an amount by which the signaled size needs to be adjusted to achieve a target ratio between the cumulative size and the signaled size.

Clause 52: A method of exchanging media data, the method comprising: determining an initial data burst size value for a data burst including packets including media data; signaling a signaled data burst size value for the data burst, the signaled data burst size value being larger than the initial data burst size value; and sending the data burst including the signaled data burst size value to a destination device.

Clause 53: A method comprising a combination of the method of any of clauses 34-46 and the method of clause 52.

Clause 54: The method of any of clauses 52 and 53, wherein determining the initial data burst size value comprises calculating a size of the packets of the data burst.

Clause 55: The method of clause 54, wherein calculating comprises calculating, by a traffic source device that is a source of the data burst.

Clause 56: The method of any of clauses 52 and 53, wherein determining the initial data burst size value comprises extracting a signaled data burst size for the data burst, and wherein signaling comprises: encapsulating each of the packets of the data burst into tunneled network packets having a tunnel header; and signaling the signaled data burst size value in the tunnel header.

Clause 57: The method of any of clauses 52-56, further comprising determining the signaled data burst size value according to a predefined rule.

Clause 58: The method of any of clauses 52-56, further comprising: receiving data representative of a dynamic policy for determining the signaled data burst size value; and determining the signaled data burst size value according to the dynamic policy.

Clause 59: The method of any of clauses 52-58, wherein the data burst comprises a first data burst of a communication session with the destination device, the initial data burst size value comprises a first initial data burst size value, and the signaled data burst size value comprises a first signaled data burst size value, the method further comprising: receiving, from the destination device, data representing a ratio between a cumulative size of the packets of the first data burst and the first signaled data burst size value; determining a second initial data burst size value for a second data burst including packets including media data; calculating a second signaled data burst size value for the second data burst, including applying the ratio to the second initial data burst size value; and sending the second data burst including the second signaled data burst size value to the destination device.

Clause 60: A device for exchanging media data, the device comprising: a memory; and a processing system implemented in circuitry and configured to: determine an initial data burst size value for a data burst including packets including media data; signal a signaled data burst size value for the data burst, the signaled data burst size value being larger than the initial data burst size value; and send the data burst including the signaled data burst size value to a destination device.

Clause 61: The device of clause 60, wherein to determine the initial data burst size value, the processing system is configured to calculate a size of the packets of the data burst.

Clause 62: The device of clause 60, wherein the data burst comprises a first data burst of a communication session with the destination device, the initial data burst size value comprises a first initial data burst size value, and the signaled data burst size value comprises a first signaled data burst size value, and wherein the processing system is further configured to: receive, from the destination device, data representing a ratio between a cumulative size of the packets of the first data burst and the first signaled data burst size value; determine a second initial data burst size value for a second data burst including packets including media data; calculate a second signaled data burst size value for the second data burst, including application of the ratio to the second initial data burst size value; and send the second data burst including the second signaled data burst size value to the destination device.

Clause 63: A computer-readable storage medium having stored thereon instructions that, when executed, cause a processing system to perform the method of any of clauses 34-46 or 52-58.

Clause 64: A device for exchanging media data, the device comprising: means for calculating a cumulative size of packets of a data burst received from a source device, the packets including media data; means for determining a signaled data burst size for the data burst; means for calculating a ratio between the cumulative size and the signaled size; and means for sending data representative of the ratio to the source device.

Clause 65: A device for exchanging media data, the device comprising: means for determining an initial data burst size value for a data burst including packets including media data; means for signaling a data burst size value for the data burst, the signaled data burst size value being larger than the initial data burst size value; and means for sending the data burst including the signaled data burst size value to a destination device.

Clause 66: The device of clause 65, wherein the device comprises a server device.

Clause 67: The device of clause 65, wherein the device comprises a source device.

Clause 68: The device of clause 65, wherein the device comprises a router that executes a user plane function (UPF).

Clause 69: A method of exchanging media data, the method comprising: receiving a data burst size value for a data burst including packets of media data; determining a larger data burst size value that is larger than the received data burst size value; allocating resources for receiving the data burst according to the larger data burst size value; and receiving the data burst via the allocated resources.

Clause 70: The method of clause 69, further comprising sending the received data burst to a client device via a radio access network (RAN).

Clause 71: A device for exchanging media data, the device comprising one or more means for performing the method of any of clauses 69 and 70.

Clause 72: The device of clause 71, wherein the one or more means comprise a processing system implemented in circuitry.

Clause 73: A method of exchanging media data, the method comprising: calculating a cumulative size of packets of a data burst received from a source device, the packets including media data; determining a signaled data burst size for the data burst; calculating a ratio between the cumulative size and the signaled size; and sending data representative of the ratio to the source device.

Clause 74: The method of clause 73, further comprising determining to send the data representative of the ratio to the source device based on the ratio.

Clause 75: The method of clause 73, wherein sending the data representative of the ratio comprises: determining that the ratio exceeds at least one threshold; and in response to the determination that the ratio exceeds the at least one threshold, sending the data representative of the ratio to the source device.

Clause 76: The method of clause 75, further comprising receiving data defining the at least one threshold from the source device.

Clause 77: The method of clause 73, wherein sending the data representative of the ratio comprises: determining that the ratio is not within a defined range; and in response to the determination that the ratio is not within the defined range, sending the data representative of the ratio to the source device.

Clause 78: The method of clause 77, further comprising receiving data defining the defined range from the source device.

Clause 79: The method of clause 73, wherein the data representative of the ratio comprises data explicitly indicating the ratio.

Clause 80: The method of clause 73, wherein the data representative of the ratio comprises data indicating an amount by which the signaled size needs to be adjusted to achieve a target ratio between the cumulative size and the signaled size.

Clause 81: The method of clause 80, further comprising: determining that the amount by which the signaled size needs to be adjusted exceeds at least one threshold; and in response to the determination that the amount by which the signaled size needs to be adjusted exceeds the at least one threshold, sending the data representative of the amount by which the signaled size needs to be adjusted to the source device.

Clause 82: The method of clause 80, further comprising: determining that the amount by which the signaled size needs to be adjusted is not within a defined range; and in response to determining that the amount by which the signaled size needs to be adjusted is not within the defined range, sending the data representative of the amount by which the signaled size needs to be adjusted to the source device.

Clause 83: The method of clause 73, wherein sending the data representative of the ratio comprises sending at least one of a Session Description Protocol (SDP) update message, a real-time transport protocol (RTP) control protocol (RTCP) message, a simple WebRTC Application Protocol (SWAP) message, or an RTP header extension including the data representative of the ratio to the source device.

Clause 84: The method of clause 73, further comprising performing IP packet reassembly of the packets of the data burst, wherein calculating the cumulative size of the packets comprises calculating the cumulative size of the packets before performing the IP packet reassembly of the packets of the data burst.

Clause 85: The method of clause 73, wherein the method is performed by a unit that performs OSI Model Layer 3 processing on packets, the method further comprising providing the ratio to a Media Session Handler (MSH).

Clause 86: A device for exchanging media data, the device comprising: a memory; and a processing system implemented in circuitry and configured to: calculate a cumulative size of packets of a data burst received from a source device, the packets including media data; determine a signaled data burst size for the data burst; calculate a ratio between the cumulative size and the signaled size; and send data representative of the ratio to the source device.

Clause 87: The device of clause 86, wherein to send the data representative of the ratio, the processing system is further configured to: determine that the ratio exceeds at least one threshold; and in response to the determination that the ratio exceeds the at least one threshold, send the data representative of the ratio to the source device.

Clause 88: The device of clause 86, wherein to send the data representative of the ratio, the processing system is further configured to: determine that the ratio is not within a defined range; and in response to the determination that the ratio is not within the defined range, send the data representative of the ratio to the source device.

Clause 89: The device of clause 86, wherein the data representative of the ratio comprises data explicitly indicating the ratio.

Clause 90: The device of clause 86, wherein the data representative of the ratio comprises data indicating an amount by which the signaled size needs to be adjusted to achieve a target ratio between the cumulative size and the signaled size.

Clause 91: A method of exchanging media data, the method comprising: determining an initial data burst size value for a data burst including packets including media data; signaling a signaled data burst size value for the data burst, the signaled data burst size value being larger than the initial data burst size value; and sending the data burst including the signaled data burst size value to a destination device.

Clause 92: The method of clause 91, wherein determining the initial data burst size value comprises calculating a size of the packets of the data burst.

Clause 93: The method of clause 91, wherein calculating comprises calculating, by a traffic source device that is a source of the data burst.

Clause 94: The method of clause 91, wherein determining the initial data burst size value comprises extracting a signaled data burst size for the data burst, and wherein signaling comprises: encapsulating each of the packets of the data burst into tunneled network packets having a tunnel header; and signaling the signaled data burst size value in the tunnel header.

Clause 95: The method of clause 91, further comprising determining the signaled data burst size value according to a predefined rule.

Clause 96: The method of clause 91, further comprising: receiving data representative of a dynamic policy for determining the signaled data burst size value; and determining the signaled data burst size value according to the dynamic policy.

Clause 97: The method of clause 91, wherein the data burst comprises a first data burst of a communication session with the destination device, the initial data burst size value comprises a first initial data burst size value, and the signaled data burst size value comprises a first signaled data burst size value, the method further comprising: receiving, from the destination device, data representing a ratio between a cumulative size of the packets of the first data burst and the first signaled data burst size value; determining a second initial data burst size value for a second data burst including packets including media data; calculating a second signaled data burst size value for the second data burst, including applying the ratio to the second initial data burst size value; and sending the second data burst including the second signaled data burst size value to the destination device.

Clause 98: A device for exchanging media data, the device comprising: a memory; and a processing system implemented in circuitry and configured to: determine an initial data burst size value for a data burst including packets including media data; signal a signaled data burst size value for the data burst, the signaled data burst size value being larger than the initial data burst size value; and send the data burst including the signaled data burst size value to a destination device.

Clause 99: The device of clause 98, wherein to determine the initial data burst size value, the processing system is configured to calculate a size of the packets of the data burst.

Clause 100: The device of clause 98, wherein the data burst comprises a first data burst of a communication session with the destination device, the initial data burst size value comprises a first initial data burst size value, and the signaled data burst size value comprises a first signaled data burst size value, and wherein the processing system is further configured to: receive, from the destination device, data representing a ratio between a cumulative size of the packets of the first data burst and the first signaled data burst size value; determine a second initial data burst size value for a second data burst including packets including media data; calculate a second signaled data burst size value for the second data burst, including application of the ratio to the second initial data burst size value; and send the second data burst including the second signaled data burst size value to the destination device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of exchanging media data, the method comprising:
calculating a cumulative size of packets of a data burst received from a source device, the packets including media data;
determining a signaled data burst size for the data burst;
calculating a ratio between the cumulative size and the signaled size; and
sending data representative of the ratio to the source device.

2. The method of claim 1, further comprising determining to send the data representative of the ratio to the source device based on the ratio.

3. The method of claim 1, wherein sending the data representative of the ratio comprises:
determining that the ratio exceeds at least one threshold; and
in response to the determination that the ratio exceeds the at least one threshold, sending the data representative of the ratio to the source device.

4. The method of claim 3, further comprising receiving data defining the at least one threshold from the source device.

5. The method of claim 1, wherein sending the data representative of the ratio comprises:
determining that the ratio is not within a defined range; and
in response to the determination that the ratio is not within the defined range, sending the data representative of the ratio to the source device.

6. The method of claim 5, further comprising receiving data defining the defined range from the source device.

7. The method of claim 1, wherein the data representative of the ratio comprises data explicitly indicating the ratio.

8. The method of claim 1, wherein the data representative of the ratio comprises data indicating an amount by which the signaled size needs to be adjusted to achieve a target ratio between the cumulative size and the signaled size.

9. The method of claim 8, further comprising:
determining that the amount by which the signaled size needs to be adjusted exceeds at least one threshold; and
in response to the determination that the amount by which the signaled size needs to be adjusted exceeds the at least one threshold, sending the data representative of the amount by which the signaled size needs to be adjusted to the source device.

10. The method of claim 8, further comprising:
determining that the amount by which the signaled size needs to be adjusted is not within a defined range; and
in response to determining that the amount by which the signaled size needs to be adjusted is not within the defined range, sending the data representative of the amount by which the signaled size needs to be adjusted to the source device.

11. The method of claim 1, wherein sending the data representative of the ratio comprises sending at least one of a Session Description Protocol (SDP) update message, a real-time transport protocol (RTP) control protocol (RTCP) message, a simple WebRTC Application Protocol (SWAP) message, or an RTP header extension including the data representative of the ratio to the source device.

12. The method of claim 1, further comprising performing IP packet reassembly of the packets of the data burst, wherein calculating the cumulative size of the packets comprises calculating the cumulative size of the packets before performing the IP packet reassembly of the packets of the data burst.

13. The method of claim 1, wherein the method is performed by a unit that performs OSI Model Layer 3 processing on packets, the method further comprising providing the ratio to a Media Session Handler (MSH).

14. A device for exchanging media data, the device comprising:
a memory; and
a processing system implemented in circuitry and configured to:
calculate a cumulative size of packets of a data burst received from a source device, the packets including media data;
determine a signaled data burst size for the data burst;
calculate a ratio between the cumulative size and the signaled size; and
send data representative of the ratio to the source device.

15. The device of claim 14, wherein to send the data representative of the ratio, the processing system is further configured to:
determine that the ratio exceeds at least one threshold; and
in response to the determination that the ratio exceeds the at least one threshold, send the data representative of the ratio to the source device.

16. The device of claim 14, wherein to send the data representative of the ratio, the processing system is further configured to:
determine that the ratio is not within a defined range; and
in response to the determination that the ratio is not within the defined range, send the data representative of the ratio to the source device.

17. The device of claim 14, wherein the data representative of the ratio comprises data explicitly indicating the ratio.

18. The device of claim 14, wherein the data representative of the ratio comprises data indicating an amount by which the signaled size needs to be adjusted to achieve a target ratio between the cumulative size and the signaled size.

19. A method of exchanging media data, the method comprising:
determining an initial data burst size value for a data burst including packets including media data;
signaling a signaled data burst size value for the data burst, the signaled data burst size value being larger than the initial data burst size value; and
sending the data burst including the signaled data burst size value to a destination device.

20. The method of claim 19, wherein determining the initial data burst size value comprises calculating a size of the packets of the data burst.

21. The method of claim 20, wherein calculating comprises calculating, by a traffic source device that is a source of the data burst.

22. The method of claim 19, wherein determining the initial data burst size value comprises extracting a signaled data burst size for the data burst, and wherein signaling comprises:
encapsulating each of the packets of the data burst into tunneled network packets having a tunnel header; and
signaling the signaled data burst size value in the tunnel header.

23. The method of claim 19, further comprising determining the signaled data burst size value according to a predefined rule.

24. The method of claim 19, further comprising:
receiving data representative of a dynamic policy for determining the signaled data burst size value; and
determining the signaled data burst size value according to the dynamic policy.

25. The method of claim 19, wherein the data burst comprises a first data burst of a communication session with the destination device, the initial data burst size value comprises a first initial data burst size value, and the signaled data burst size value comprises a first signaled data burst size value, the method further comprising:
receiving, from the destination device, data representing a ratio between a cumulative size of the packets of the first data burst and the first signaled data burst size value;
determining a second initial data burst size value for a second data burst including packets including media data;
calculating a second signaled data burst size value for the second data burst, including applying the ratio to the second initial data burst size value; and
sending the second data burst including the second signaled data burst size value to the destination device.

26. A device for exchanging media data, the device comprising:
a memory; and
a processing system implemented in circuitry and configured to:
determine an initial data burst size value for a data burst including packets including media data;
signal a signaled data burst size value for the data burst, the signaled data burst size value being larger than the initial data burst size value; and
send the data burst including the signaled data burst size value to a destination device.

27. The device of claim 26, wherein to determine the initial data burst size value, the processing system is configured to calculate a size of the packets of the data burst.

28. The device of claim 26, wherein the data burst comprises a first data burst of a communication session with the destination device, the initial data burst size value comprises a first initial data burst size value, and the signaled data burst size value comprises a first signaled data burst size value, and wherein the processing system is further configured to:
receive, from the destination device, data representing a ratio between a cumulative size of the packets of the first data burst and the first signaled data burst size value;
determine a second initial data burst size value for a second data burst including packets including media data;
calculate a second signaled data burst size value for the second data burst, including application of the ratio to the second initial data burst size value; and
send the second data burst including the second signaled data burst size value to the destination device.

29. The device of claim 27, wherein to determine the signaled data burst size value, the processing system is configured to determine the signaled data burst size value according to a predefined rule.

30. The device of claim 27, wherein to determine the signaled data burst size value, the processing system is configured to:
receive data representative of a dynamic policy for determining the signaled data burst size value; and
determine the signaled data burst size value according to the dynamic policy.
